(19) United States
(12) Patent Application Publication
(10) Pub. No.: US 2006/0067179 A1
(43) Pub. Date: Mar. 30, 2006

(54) Optical information recording device and optical information reproduction device

(75) Inventors: Kozo Matsumoto, Yokohama-shi (JP); Hideyoshi Horimai, Yokohama-shi (JP)

Correspondence Address: KODA & ANDROLIA, 2029 CENTURY PARK EAST, SUITE 1140, LOS ANGELES, CA, 90067, US

(73) Assignee: Optware Corporation

(21) Appl. No.: 11/229,272

(22) Filed: Sep. 15, 2005

(30) Foreign Application Priority Data
Sep. 16, 2004 (JP) 2004-270026

(51) Int. Cl. G11B 19/02

(52) U.S. Cl. 369/47.1; 369/59.1; 369/53.1

(57) ABSTRACT

The present invention provides an optical information recording device and reproduction device which enable accurate recording and reproduction of information.

The present invention comprises a light source 103, a deflection element 109 for changing the traveling direction of light emitted from the light source, a means 113 for generating information light holding information using light of which the traveling direction has been changed by the deflection element, a means 113 for generating recording reference light using light of which the traveling direction has been changed by the deflection element, an objective lens 127 for irradiating information light and recording reference light to the moving recording medium 151, and a control means 163 for controlling the deflection element and enabling the irradiation position of the objective lens 127 to the recording medium 151 to follow the movement of the recording medium 151.

### BACKGROUND OF THE INVENTION

1. Field of the Invention

The present invention relates to an optical information recording device for recording information on a recording medium to which information is recorded, utilizing holography, and an optical information reproduction device for reproducing information from a recording medium to which information is recorded, utilizing holography.

2. Description of the Related Art

Conventionally, holographic recording for recording information to a recording medium, utilizing holography, is generally performed by superimposing information light holding image information, comprised in recording light, and recording reference light within the recording medium and writing the interference pattern formed at this time to the recording medium. When reproducing the recorded information, the image information is reproduced by diffraction due to the interference pattern by irradiating this recording medium with reproduction reference light (refer to Japanese Patent Laid-Open Publication No. 2002-375452 (particularly, to paragraph 0024 to paragraph 0027 thereof)).

In recent years, volume holography, digital volume holography in particular, has been developed on a practical level and is receiving attention for ultra-high-density optical recording. Volume recording is a system for writing interference patterns three dimensionally, actively using the thickness direction of the recording medium as well, and can enhance diffraction efficiency by increasing thickness and increase recording capacity using multiplex recording. In addition, digital volume holography is a computer-oriented holographic recording system which limits the image information to be recorded to binarized digital patterns, while implementing the same recording media and recording system as volume holography. In this digital volume holography, graphic information such as analog illustration, for example, is temporarily digitalized and developed into binary digital pattern information which is recorded as image information. When reproducing, this image information is returned to the original graphic information and displayed by reading and decoding this information. Through this, the original information can be reproduced with extreme accuracy by performing differential detection or encoding binary data and correcting errors, even if the SN ratio (signal-to-noise ratio) is somewhat poor when reproducing.

Incidentally, as a system for holographic recording, a system which uses an optical pick-up device including an optical system for recording information to recording media and reproducing information from recording media, utilizing disk-shaped recording medium in the same way as CDs (compact disc), DVDs (Digital Versatile Disc) and the like, is effective.

Generally, in optical disk devices such as CDs and DVDs, focus servo and tracking servo are performed by driving the objective lens within the optical pick-up device, while rotating the disk-shaped recording medium. In other words, when performing focus servo, positioning for focusing the objective lens (distance between the objective lens and recording medium) is performed by moving the objective lens in the optical axis direction, and when performing tracking servo, positioning of track position is performed by moving the objective lens in the radial direction of the disk-shaped recording medium.

Tracking servo was performed by moving an optical head, including light source, optical system and objective lens, in the radial direction of the recording medium, as tracking servo proposed in conventional optical information reproduction device utilizing holography (refer to Japanese Patent Laid-Open Publication No. 2002-375452 (particularly, to paragraph 0024 to paragraph 0027 thereof)).

In addition, in optical disk devices such as CDs and DVDs, semiconductor laser is used as light source for generating information recording/reproduction light. It is preferable to use a practical semiconductor laser as the light source for information light and reference light in holographic recording, as well, as in the foregoing common optical disk devices. However, when using semiconductor laser light as laser light in holographic recording, recording of information to the recording medium must be performed for a long period of time because this semiconductor laser is a laser with low energy.

Therefore, when recording information to a recording medium using semiconductor laser light, the position of the semiconductor laser light must be changed so as to follow the rotation of the recording medium. Hereafter, moving the irradiation position so as to follow this moving recording medium is called “following servo”.

In conventional optical information reproduction device using holography, following servo for enabling the irradiation position to follow by moving the optical head, including light source, optical system, and objective lens, according to the circumference direction of the recording medium is proposed (refer to Japanese Patent Laid-Open Publication No. 2002-375452 (particularly, to paragraph 0024 to paragraph 0027 thereof)).

### SUMMARY OF THE INVENTION

However, it is difficult to drive the following servo, described in the foregoing Japanese Patent Laid-Open Publication No. 2002-375452, at a high-speed because the movable optical head is heavy, and this led to the reduction in transfer rate because the rotation speed of the recording medium had to be reduced to a range enabling the optical head to follow.

This regards to this issue, the applicant has filed an invention for enabling the irradiation position to follow the movement of the recording medium, by shifting the position of light incident to the recording medium, by changing the angle of the light incident from a collimator lens to a polarized beam splitter, by moving the collimator, which forms light from a light source into parallel light, such as to follow the movement of the recording medium, as Patent No. 2003-193964.

FIG. 10 is a configuration diagram showing an embodiment of the optical information recording/reproduction device of Patent No. 2003-193964. In FIG. 10, a disk-shaped recording medium 11, to which information is recorded, comprises a first transparent substrate 12, a reflective layer 13, a transparent intermediate payer (unillustrated), an information recording layer 14, and a second transparent substrate 15. Furthermore, concentric or spiral tracks are formed on the recording medium 11, though unillustrated, a plurality of address servo regions are provided, evenly spaced, in each track, and one or a plurality of information recording regions are provided between adjacent address servo regions.

FIG. 10 is a cross-sectional view in the tangential direction of the circumference in the irradiation position of the recording medium 11. The recording medium in FIG. 10 moves in the direction of the arrow by rotating.

In addition, the optical information recording/reproduction device 20 comprises a recording/reproduction light source 22, a first collimator lens 24, a polarized beam splitter 26, spatial light modulator (information expression means) 28, a pair of relay lenses 30a and 30b, a servo-reading element 32, a second collimator lens 34, a dichroic mirror 36, ¼ wavelength plate 38, an objective lens 40, and a optical detector 42. With regards to the functions of these components of the optical information recording/reproduction device in FIG. 10, descriptions are herein omitted because they are no different from the components in the embodiments of the present invention.

In FIG. 10, a driving means 44, such as a linear motor, for moving the first collimator lens 24 horizontally within the flat surface thereof is connected thereto. The driving means 44 is configured such as to drive the first collimator 24 according to the position information of the recording medium 11, detected by the optical detector of the servo-reading element 32.

Although, if the first collimator lens 24 in FIG. 10 is moved in the left direction, indicate by the solid line, from the center position, indicated by the broken line, laser light emitted from a light source 22 is formed into an almost parallel light when passing through the first collimator lens 24, the entry angle to the half-reflective surface 27 of the polarized beam splitter 26, indicated by the solid line, differs from the angle which is indicated by the broken line. Therefore, the entry angle to the spatial light modulator 28 and the emission angle therefrom differ from the angle which is indicated by the broken line. As a result, the image forming position between both relay lenses 30a and 30b, the entry angle to the half-reflective surface 37 of the dichroic mirror 36 and the like differ, and light irradiated to the information recording layer 14 of the recording medium 11 is irradiated to the position indicated by the solid line, which differs from the position indicated by the broken line. It can be understood that the irradiation position on the recording medium 11, indicated by this solid line, follows the rotary motion of the recording medium 11.

However, when actually performing holographic recording using a semiconductor laser, because the cross-section of the laser light emitted from the semiconductor laser has an elliptical shape and the beam intensity distribution within the beam is uneven, the optical element, which equalizes the beam intensity distribution within the beam by making the cross-section of the beam a circular-shape, is placed between the first collimator lens 24 and the spatial light modulator (information expression means) 28. An anamorphic prism (107 in FIG. 1, described hereafter), for example, is given as an optical element which equalizes beam intensity distribution.

As described earlier, if the first collimator lens 24 is moved and the light irradiation position is moved such as to follow the recording medium, the entry angle of the laser light incident to the optical element, which equalizes beam intensity, differs because the travel direction of the laser light is changed. As a result, because the beam intensity of the laser light cannot be corrected such as to be even and the evenness of beam intensity changes with the changed in entry angle, as well, the entire information cannot be recorded accurately and the reliability of recording/reproduction is reduced.

In addition, because all that was required out of conventional optical disc devices, such as CD and DVD, which does not utilize holography, was for the optical system to transmit light intensity (energy) only, focus servo and tracking servo could be performed by a double shaft driving mechanism for moving the objective lens in the optical axis direction and the radial direction of the recording medium. However, the following issues arose when performing tracking servo using the double shaft driving mechanism in holographic recording.

The optical information recording/reproduction device utilizing holography, shown in FIG. 10, is that which records interference patterns of pattern to which Fourier transformation of two-dimensional digital pattern information has been performed by objective lens 40, and therefore, it was necessary to perform image formation of two-dimensional digital pattern information, shown in spatial light modulator (information expression means) 28, in the entrance pupil plane of the objective lens 40. In addition, it was necessary to ultimately perform image formation of reproduction light, generated from the information recording layer 14 of the recording medium 11 by the reproduction reference light, in the optical detector 42, when reproducing.

In such holographic recording, because the center of the objective lens 40 and optical axis become misaligned when only the objective lens 40 is moved in the radial direction of the recording medium, as in optical disk devices, such as CD and DVD, when performing tracking servo, light held by the two-dimensional digital pattern information is condensed obliquely by the objective lens 40. FIG. 11 is a diagram showing an optical path when the objective lens 40 is moved and tracking servo is performed. In FIG. 11, when in the state indicated by the solid line, the light held by the two-dimensional digital pattern information is condensed perpendicular to the reflective layer 13 of the recording medium 11 by the objective lens 40 because the center 40a of the objective lens 41 and the optical axis L of the incident light matches. Next, because the position of the incident light does not change when the position of the objective lens 40, indicated by the solid line, is moved to the position of the objective lens 41, indicated by the dotted line, the center 41a of the objective lens 41 and the optical axis L of the incident light become misaligned, and the light held by the two-dimensional digital pattern information is condensed obliquely on the extension line of the center 41a of objective lens 41 (indicated by the dashed line). Therefore, although the irradiation position can be moved from the position indicated by the solid line to the position indicated by the dotted line and tracking servo can be performed, the shape of the convergent light beam differs with the solid-line objective lens 40 and the dotted-line objective lens 41, and the patterns of the Fourier transformation of the two-dimensional digital pattern information differs.

In other words, reliability in recording/reproducing information is reduced significantly because, when tracking servo is performed by moving the objective lens 40, the recorded interference pattern differs even when the same two-dimensional digital pattern information is recorded.

Furthermore, in holographic recording, angle multiplexing system recording, which superimposes a plurality of information on the same position and records, can be performed by changing the irradiation angle of the information light and recording reference light when recording. In other words, if the angle of the irradiated reproduction reference light during reproduction differs from that during recording, the recorded information cannot be reproduced. Therefore, because the reliability in recording/reproducing information is reduced significantly if condensation by the objective lens 40 is oblique, performing tracking servo by moving only the objective lens during holographic recording/reproduction becomes problematic from this perspective, as well.

In the Japanese Patent Laid-Open Publication No. 2002-375452, condensation by objective lens 40 is not oblique because tracking servo is performed by moving the optical head in the radial direction of the recording medium. However, as with the problem in following servo, this lead to a reduction in transfer rate because the moveable optical head is heavy and difficult to drive at a high-speed, and it is necessary to reduce the rotation speed of the recording medium.

The present invention has been achieved with these issues in mind, and an object of the invention is to provide an optical recording device and reproduction device which enable accurate recording and reproduction of information by consistently irradiating light to a recording medium in the same state, during holographic recording and reproduction.

More specifically, an object of the invention is to provide an optical recording device and reproduction device which enable accurate recording and reproduction of information by consistently irradiating light to a recording medium in the same state, even when the irradiation position is moved such as to follow the movement of the recording medium. In addition, an object of the invention is to provide an optical recording device and reproduction device which enable accurate recording and reproduction of information by consistently irradiating light to a recording medium in the same state, even when the optical element of the inner part of the optical head is driven and positioned.

In order to achieve the foregoing objects, the optical information recording device utilizing holography of the present invention comprises: a light source; a deflection element for changing the traveling direction of light emitted from the light source; a means for generating information light holding information using light of which the traveling direction has been changed by the deflection element; a means for generating recording reference light using light of which the traveling direction has been changed by the deflection element; an objective lens for irradiating information light and recording reference light to the moving recording medium; and a control means for controlling the deflection element and enabling the irradiation position of the objective lens to the recording medium to follow the movement of the recording medium.

Furthermore, in the foregoing optical information recording device, it is preferable that the deflection element comprises a reflective optical element and a driving means for rotating the reflective optical element.

Still further, in the foregoing optical information recording device, the light incident to the deflection element is parallel light of which the beam intensity distribution has been equalized.

Still further, the foregoing optical information recording device can comprise a positioning mechanism for rotating reflective optical element for directing the traveling direction of the information light and the recording reference light to the objective lens and changing the irradiation position to the recording medium, and in particular, it is preferable that the rotational center of the reflective optical element of the positioning mechanism is positioned in the entrance pupil plane of the objective lens.

In addition, the foregoing optical information recording device comprises: a pair of relay lenses for performing image formation of the information light and the recording reference light on the entrance pupil plane of the objective lens; a reflective optical element placed in the focal position between the pair of relay lenses; and a driving means for rotating this reflective optical element; wherein the objective lens can be moved in a direction parallel to the front surface of the recording medium, and the reflective optical element between the pair of relay lenses can be rotated in correspondence to the movement of the objective lens.

In addition, another optical information recording device utilizing holography of the present invention comprises: a light source; a means for generating information light holding information using light emitted from the light source; a means for generating recording reference light using light emitted from the light source; a reflective optical element for directing the traveling direction of the information light and the recording reference light to the objective lens; a driving means for rotating the reflective optical element; and an objective lens for irradiating the information light and the recording reference light to the recording medium; wherein the rotational center of the reflective optical element of the positioning mechanism is positioned in the entrance pupil plane of the objective lens.

In addition, another optical information recording device utilizing holography of the present invention comprises: a light source; a means for generating information light holding information using light emitted from the light source; a means for generating recording reference light using light emitted from the light source; a pair of relay lenses for performing image formation of the information light and recording reference light on the entrance pupil plane of the objective lens; a reflective optical element placed in the focal position between the pair of relay lenses; a driving means for rotating this reflective optical element; and an objective lens for irradiating the information light and the recording reference light to the recording medium; wherein the objective lens can be moved in a direction parallel to the front surface of the recording medium, and the reflective optical element can be rotated in correspondence to the movement of the objective lens.

Next, in order to achieve the foregoing objects, the optical information reproducing device utilizing holography of the present invention comprises: a light source; a deflection element for changing the traveling direction of light emitted from the light source; a means for generating reproduction reference light using light of which the traveling direction has been changed by the deflection element; an objective lens for irradiating the reproduction reference light to a moving recording medium and receiving reproduction light generated from the recording medium; and a control means for controlling the deflection element and enabling the irradiation position of the objective lens to the recording medium to follow the movement of the recording medium.

Furthermore, in the foregoing optical information reproduction device, it is preferable that the deflection element comprises a reflective optical element and a driving means for rotating the reflective optical element.

Still further, in the foregoing optical information reproduction device, the light incident to the deflection element is parallel light of which the beam intensity distribution has been equalized.

Still further, the foregoing optical information reproduction device can comprise a positioning mechanism for rotating reflective optical element for directing the traveling direction of the reproduction reference light to the objective lens and changing the irradiation position to the recording medium, and in particular, it is preferable that the rotational center of the reflective optical element of the positioning mechanism is positioned in the entrance pupil plane of the objective lens.

In addition, the foregoing optical information reproduction device comprises: a pair of relay lenses for performing image formation of the reproduction reference light on the entrance pupil plane of the objective lens; a reflective optical element placed in the focal position between the pair of relay lenses; and a driving means for rotating this reflective optical element; wherein the objective lens can be moved in a direction parallel to the front surface of the recording medium, and the reflective optical element between the pair of relay lenses can be rotated in correspondence to the movement of the objective lens.

In addition, another optical information reproduction device utilizing holography of the present invention comprises: a light source; a means for generating reproduction reference light using light emitted from the light source; a reflective optical element for directing the traveling direction of the reproduction reference light to the objective lens; a driving means for rotating the reflective optical element; and an objective lens for irradiating the reproduction reference light to the recording medium; wherein the rotational center of the reflective optical element of the positioning mechanism is positioned in the entrance pupil plane of the objective lens.

In addition, another optical information recording device utilizing holography of the present invention comprises: a light source; a means for generating reproduction reference light using light emitted from the light source; a pair of relay lenses for performing image formation of the reproduction reference light on the entrance pupil plane of the objective lens; a reflective optical element placed in the focal position between the pair of relay lenses; a driving means for rotating this reflective optical element; and an objective lens for irradiating the reproduction reference light to the recording medium; wherein the objective lens can be moved in a direction parallel to the front surface of the recording medium, and the reflective optical element can be rotated in correspondence to the movement of the objective lens.

According to the present invention, superior information recording and reproduction can be performed, even if information is recorded to and reproduced from a moving recording medium using a low-energy light, because the irradiation position follows the moving recording medium.

In addition, in holographic recording and reproduction, an accurate information recording and reproduction can be performed because, even if the irradiation position is moved, light can be irradiated to the recording medium in the same state.

### BRIEF DESCRIPTION OF THE DRAWINGS

FIG. 1 (A) is a rough top view of an embodiment of a pick-up device in the optical information recording/reproduction device of the present invention, and (B) is a rough side view thereof;

FIG. 2 is a diagram explaining an embodiment of the following servo mechanism of the present invention;

FIG. 3 is a diagram an embodiment of the following servo mechanism of the present invention;

FIG. 4 is a diagram explaining an embodiment of the positioning mechanism of the present invention;

FIG. 5 is an overview showing the entire configuration of the optical information recording/reproduction device of the present invention;

FIG. 6 is an overview showing another embodiment of a portion of the optical system in the pick-up device of the present invention;

FIG. 7 (A) and (B) are overviews showing other embodiments of a portion of the optical system in the pick-up device of the present invention;

FIG. 8 (A) is a rough top view showing another embodiment of the pick-up device in the optical information recording/reproduction device of the present invention, and (B) is a rough side view thereof;

FIG. 9 is a diagram explaining another embodiment of the positioning mechanism of the present invention;

FIG. 10 is an overview showing a conventional optical information recording/reproduction device; and

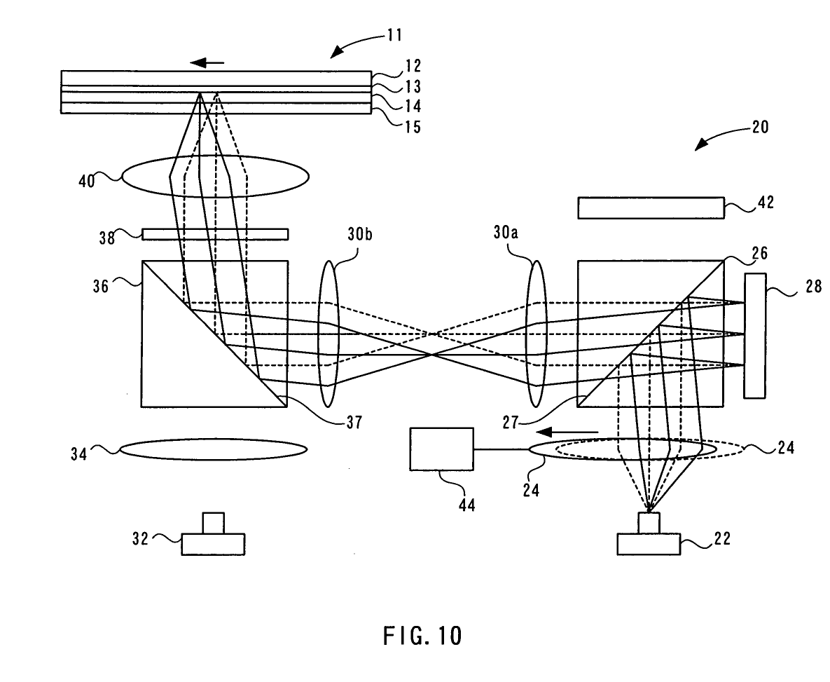

FIG. 11 is a diagram explaining a conventional positioning mechanism.

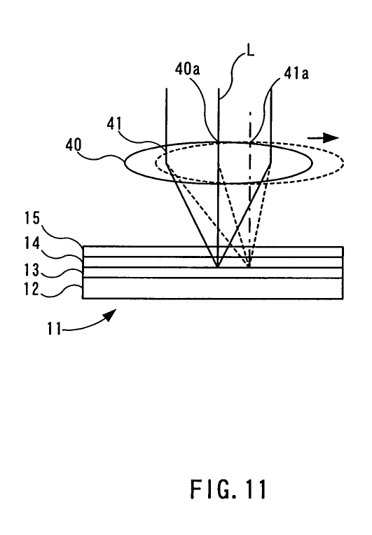

### DESCRIPTION OF THE PREFERRED EMBODIMENTS

The embodiments of the present invention are described below by the drawing.

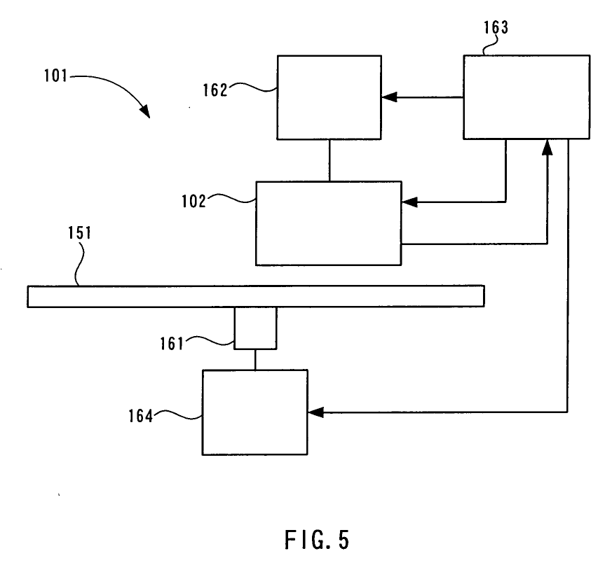

First, the entire configuration of an optical information recording/reproduction device 101 according to the present embodiment is described with reference to FIG. 5. This optical information recording/reproduction device 101 comprises a recording medium placement part 162 for placing a recording medium 151, a pick-up device 102, a pick-up driving means 162, and a control means 163.

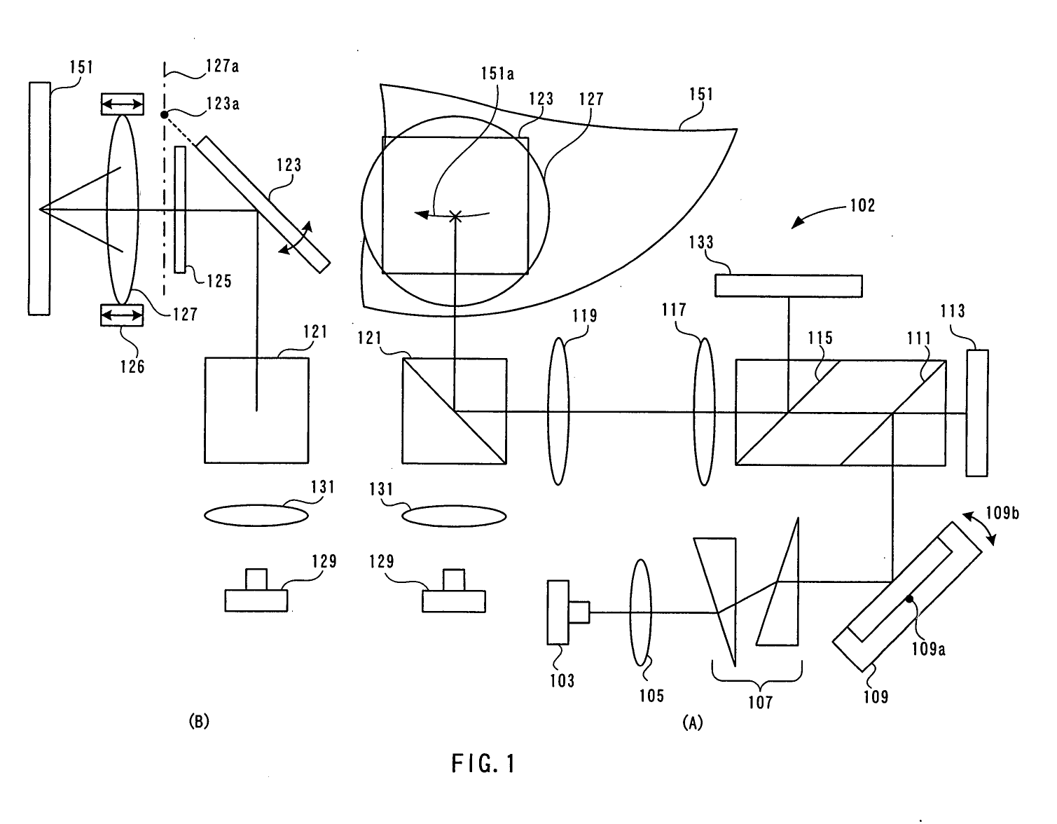

Recording medium 151 has an information recording layer for recording a hologram. Although, in FIG. 1, described hereafter, an example is shown wherein a disk-shaped recording medium 151 is rotated, the recording medium 151 is not limited to a disk-shape. In addition, although the recording medium 151 must be moving when recording/reproducing in order to perform following servo, the recording medium 151 can be fixed if only performing positioning, such as tracking servo. For example, the present invention can be applied to an instance wherein the irradiation position is aligned to a predetermined position on the recording medium 151, using a card-type recording medium 151.

When performing recording/reproduction while moving the recording medium 151, the invention further comprises a recording medium driving means 164 for driving a recording medium placement part 161 and moving the recording medium 151, and the recording medium driving means 164 is controlled by a control means 163, such as to keep the movement speed of the recording medium 151 at a predetermined value.

When using a disk-shaped recording medium as the recording medium 151 and a system for performing recording/reproduction while rotating the recording medium 151, a disk driving mechanism used in CD drives and DVD drives can be used, and further, this is preferable because compatibility with CD drives and DVD drives can be facilitated. In this case, a recording medium driving means 64 for rotating the recording medium placement part 161 is provided and controlled by a control means 162 so as to keep the rotation speed of the recording medium 151 at a predetermined value.

In addition, it is preferable to record information for positioned to the recording medium 151 beforehand and implement a feedback mechanism for the positioning of the irradiation position, such as to perform a more precise positioning. For example, as the recording medium 151, a reflective layer can be laminated and formed on an information recording layer, pits can be formed on the front surface of the reflective layer as positioning information, and positioning information can be recorded beforehand. When using light which has a differing wavelength from that for recording light or reproduction light as the light for reading positioning information, a reflective layer for reflecting recording or reproduction light can be provided separately from the reflective layer for the light for reading positioning information, on to which pits have been formed. For example, if a dichroic mirror layer which reflects recording and reproduction light and passes light for reading positioning information is formed between the reflective layer and the information recording layer, positioning information can be recorded, superimposed on the recording/reproduction region, and furthermore, a pick-up device 102 can be placed on one side of the recording medium, thus, miniaturizing the recording/reproduction device.

Pick-up device 102 records information by irradiating information light and recording reference light to the recording medium 151 when recording, and, when reproducing, irradiates reproduction reference light to the recording medium 151, detects reproduction light, and reproduces information recorded to the recording medium 151. Pick-up device 102 preferably can be moved to the general recording position or reproduction position, as an optical head which includes light source to objective lens.

Information reproduced from the recording medium 151 by the pick-up device 102 is sent to the control means 163 and decoded by the signal processing feature of the control means 153. In addition, if the pick-up device 102 has a feature for reading the positioning information of the recording medium 151, the positioning information obtained from the recording medium 151 by the pick-up device 102 is sent to the control means 163, misalignment in position and focal point is detected by a detection feature of the control means 163 and fed back to the positioning mechanism or following servo mechanism within the pick-up driving means 162 or pick-up device 102. The positioning mechanism and the following servo mechanism within the pick-up device 102 are explained in the structure of the pick-up device 102, described hereafter.

Pick-up driving means 162 performs a rough positioning by moving the pick-up device 102. Subsequently, a precise positioning is performed by the positioning mechanism within the pick-up device 102. A linear motor, for example, can be used as a pick-up driving means 162.

Control means 163 controls the optical element within the pick-up device 102 and positions the irradiation position. Furthermore, the control means 163 can control the pick-up driving means 162, control the movement of the pick-up device 102, encode information to be recorded using the signal processing feature and send it to the spatial light modulator of the pick-up device 102, and enable the information to be recorded to the recording medium 151 by the pick-up device 102.

Control means 163 can have, for example, a CPU (central processing unit), ROM (read only memory), and RAM (random access memory), and be configured such that the CPU actualizes the functions of the control means 163 by executing a program stored in ROM with RAM as the work space.

FIG. 1(A) is a rough top view of the pick-up device 102 in the optical information recording/reproduction of the present embodiment (view seen from the direction facing the recording medium), and FIG. 1(B) is a rough side view of the pick-up device 102 (a cross-sectional view in the radial direction of the irradiation position of the recording medium 151). Recording medium 151 moves in the direction of arrow 151a in FIG. 1(A) and the direction perpendicular to the paper surface in FIG. 1(B).

Pick-up device 102 comprises a recording/reproduction light source 103, a first collimator lens 105, an optical element 107 for equalizing beam intensity, a deflection element 109, a first polarized beam splitter 111, a spatial light modulator (information expression means) 113, a second polarized beam splitter 115, a pair of relay lenses 117 and 119, a dichroic mirror 121, a reflective optical element 123, a ¼ wavelength plate 125, an objective lens 127, a servo-reading element 129, a second collimator lens 131 and a optical detector 133.

Recording/reproduction light source 103 emits light for forming information light and recording reference light for recording information and light for forming reproduction reference light for reproducing information. A semiconductor laser 103, for example, which generates a coherent linearly polarized light beam, can be used as light source 103. It is advantageous for the wavelength to be short in order to perform high-density recording, and it is preferable for this recording/reproduction light source 103 to implement blue laser or green laser. In addition, a solid-state laser can be used as the light source 103.

The first collimator lens 105 turns the divergence light beams from the recording/reproduction light source 103 into parallel light beams.

Optical element 107 equalizes the beam intensity distribution of light which has been turned into parallel light by the first collimator lens 105. Generally, the beam intensity distribution of emission light emitted from a light source s uneven and must be equalized. For example, if semiconductor laser is used, because the cross-section of the emission light has an elliptical shape and the beam intensity distribution within the light beam is uneven, the shape of the cross-section of the light beam must be made circular. Therefore, in FIG. 1, two anamorphic prisms (prisms of which the power in the vertical direction and horizontal direction differ) are used as the optical element 107. One-prism method or cylindrical lens method can also be used as the optical element 107 for equalizing beam intensity. If light source 103 which emits light with even beam intensity distribution, for example, a solid-state laser, is used, optical element is unnecessary because light with equalized beam intensity distribution can be emitted.

Deflection element 109 changes the traveling direction of the light, and the traveling direction of light can be changed in the direction corresponding to the movement direction of the recording medium 151 (the direction of arrow 109b in FIG. 1(A)). As deflection element 109, there are, for example, that which mechanically moves the optical element and that which electrically changes the refraction angle of the optical element. In FIG. 1, the reflective optical element and driving means are combined, and deflection is performed by the driving means rotating the reflective optical element in the direction of arrow 109b with the axis 109a, perpendicular to the paper surface, as the center. A mirror, a reflective prism and the like can be used as the reflective optical element. A refractive optical element, such as a deflection prism can be used in place of the reflective optical element in FIG. 1 and the refractive optical element can be rotated.

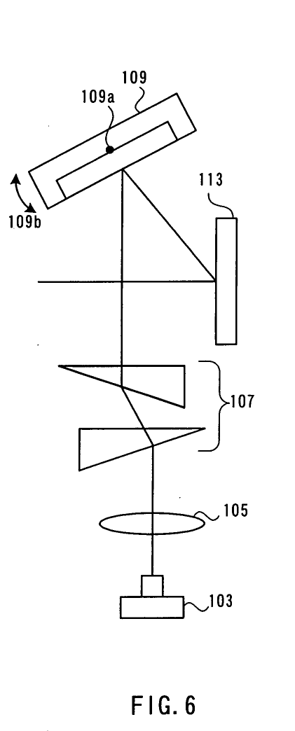

In addition, the deflection element 109 is not limited to the position in FIG. 1 and can be placed somewhere between the light source 103 and the spatial light modulator 113. For example, FIG. 6 is a configuration of an optical element from the light source 103 to the spatial light modulator 113, when DMD (digital micromirror device) is used as the spatial light modulator. As shown in FIG. 6, the deflection element 109 can be used as an optical element for directing the traveling direction of light to the spatial light modulator 113. More preferably, light of which the beam intensity distribution has been equalized is incident to the deflection element 109. In FIG. 1 and FIG. 6, parallel light of which the beam intensity distribution has been equalized by the first collimator lens 105 and optical element 107 is incident to the deflection element 109.

The deflection element 109 is controlled by the control means 163 and functions as a following servo mechanism for enabling the irradiation position of the objective lens 127 to follow the movement of recording medium 151. This will be described in detail when explained the operations of the optical information recording and reproduction device of the present invention.

The first polarized beam splitter 111 has a half-reflective surface which reflects or passes linearly polarized light (for example, polarized light P) and reflects or passes linearly polarized light (for example, polarized light S) perpendicular to the polarized light. In FIG. 1, the first polarized beam splitter 111 reflects the light beam emitted from the recording/reproduction light source 103 towards the spatial light modulator 113 and passes information light and recording reference light of which the polarizing direction has been rotated 90° by the spatial light modulator 113. As shown in FIG. 6, if the optical axis of light incident to the spatial light modulator 113 and the optical axis of light emitted from the spatial light modulator 113 are not superimposed, separation by the first polarized beam splitter is unnecessary, and therefore, the first polarized beam splitter 111 is unnecessary.

A transmitting-type or a reflective-type spatial light modulator which has numerous pixels aligned in a lattice and can modulate the phase and/or the intensity of emission light for every pixel can be used as the spatial light modulator 113. DMD and matrix-type liquid crystal elements can be used as spatial light modulator. DMD can spatially modulate intensity by modulating the reflection direction of the incident light for every pixel and spatially modulate the phase by modulating the reflection position of the incident light for every pixel. Liquid crystal elements can spatially modulate the intensity and phase of incident light by controlling the orientation state of the liquid crystals for every pixel. For example, the phase of light can be spatially modulated by setting the phase of the emission light for every pixel to either one of two values which differ from each other by π radians. In FIG. 1, the spatial light modulator is configured to rotate the polarization direction of the emission light by 90° to the polarization direction of the incident light.

Then, information light which holds two-dimensional digital pattern information can be generated by spatially modulating light from light source 103 by the two-dimensional digital pattern information shown in the display surface of the spatial light modulator 113.

In addition, in FIG. 1 the spatial light modulator 113 also functions as a reference light generation means for generating reference light for recording when recording and reference light for reproduction when reproducing from the light from the light source. As shown in FIG. 1, when forming information light and reference light by one spatial light modulator, two areas are provided in the spatial light modulator, information light is formed in one area and reference light is formed in the other area.

Reference light generation means can be provided separately from the spatial light modulator 113, which is an information light generation means. For example, light from light source 103 can be divided by a beam splitter or the like, information light can be generated by the spatial light modulator 113 from one light, and reference light can be generated from the other light. In this case, an optical system for propagating the other light, including an optical element for dividing light from light source 103, is the reference light generation means.

Furthermore, reference light can be spatially modulated by providing a separate spatial light modulator within the optical system for propagating the other light. In this case, as with the information light, because image formation of the two-dimensional digital pattern information of the reference light must be performed in the in the entrance pupil plane of the objective lens 127, the spatial light modulator for generating information light and the spatial light modulator for generating reference light have a conjugated relationship and are propagated by a pair of relay lenses. Furthermore, when reference light is spatially modulated, reproduction reference light is spatially modulated in the same modulation pattern as the modulation pattern of the recording reference light irradiated when information recorded to the recording medium is recorded.

In the recording/reproduction device 101 of the present invention, the center of the light beam passing though the center of the two-dimensional digital pattern information of spatial light modulator 113, rather than the center of the light beam emitted from the light source, is the optical axis of the optical system. This is because the optical path for information light, recording reference light and reproduction reference light generated in the spatial light modulator 113 is the irradiation position in the recording medium 151. Because of the following servo mechanism by the deflection element 109, described hereafter, even when the angle of light incident to the spatial light modulator 113 changes, the cross-section of light emitted from light source 103 is made larger than the two-dimensional digital pattern information, such that light is irradiated on the entire two-dimensional digital pattern information of spatial light modulator 113.

The second polarized beam splitter 115 passes reproduction reference light when reproducing and reflects reproduction light generated from the recording medium by the reproduction reference light towards the optical detector 133.

The first and second relay lenses 117 and 119 are placed between the spatial light modulator 113 and the objective lens 127 and are placed such as to perform image formation of the image shown in the spatial light modulator 113 in the entrance pupil plane of the objective lens 127. In other words, they are placed such that the distance from the spatial light modulator 113 to the first relay lens 117 is the focal distance f1 of the first relay lens 117, the distance from the second relay lens 119 to the entrance pupil plane of the objective lens 127 is the focal distance f2 of the second relay lens 119, and the distance between the first and second relay lenses 117 and 119 is the sum of the focal distance f1 of the first relay lens 117 and the focal distance f2 of the second relay lens 119.

In addition, in FIG. 1, the first and second relay lenses 117 and 119 are placed between the objective lens 127 and the optical detector 133 and are placed such as to perform image formation with the image in the exit pupil surface of the objective lens of the reproduction light generated from the information recording layer of the recording medium by the reproduction reference light as the real image, once again. In other words, they are placed such that the distance from the exit pupil surface of the objective lens 127 to the second relay lens 119 becomes focal distance f2, the distance from the first relay lens 117 to the optical detector 133 becomes focal distance f1, and the distance between the first and second relay lenses 117 and 119 becomes the sum of focal distance f1 and focal distance f2.

The placement of the foregoing pair of relay lenses 117 and 119 changes by placing other optical elements accordingly. For example, is a magnifying lens is placed between the first relay lens 117 and the optical detector 133, it is placed such that the distance from the first relay lens 117 to the entrance pupil plane magnifying lens becomes focal distance f1.

Dichroic mirror 121 is placed such as to irradiate light from the servo-reading element 129 to the same position as the recording or reproduction light. In other words, it is configured such that, using the difference in wavelengths of light from the servo-reading element 129 and recording or reproduction light, the light of one wavelength is passed and the light of the other wavelength is reflected. In FIG. 1, light from the recording/reproduction light source 103 is reflected and the light from the servo-reading element 129 is passed. In this case, if dichroic mirror layer for reflecting recording or reproduction light and passing light from the servo-reading element 129 is formed within the recording medium 151, as well, positioning information can be recorded, superimposed in the recording/reproduction region. If servo-reading element 129 is not provided, the dichroic mirror 121 is unnecessary.

Reflective optical element 123 reflects the traveling direction of light towards the objective lens 127 and is not required depending on the configuration of the optical system. Although a mirror is generally used as the reflective optical element 123, a reflective prism and the like can be used as well.

Furthermore, the reflective optical element 123 can also be allowed to rotate and be used as a positioning mechanism in a uniaxial direction. In this case, it is preferable to place the rotational center 123a of the reflective optical element 123 such that image formation of the image of spatial light modulator 113, propagated by the pair of relay lenses 119 and 117, to the entrance pupil plane of the objective lens 127 is performed almost normally (including normally).

In order perform image formation of a normal image to the entrance pupil plane 127, the rotational center 123a of the reflective optical element 123 is placed in the image-side focal position of the objective lens 127. If the rotational center 123a is dislocated from the image-side focal position of the objective lens 127, image formation of the image propagated by the pair of relay lenses 119 and 117 to the entrance pupil plane 127a cannot be performed normally, the interference pattern in the recording medium 151 is changed, and therefore, the reliability of information recording and reproduction is reduced.

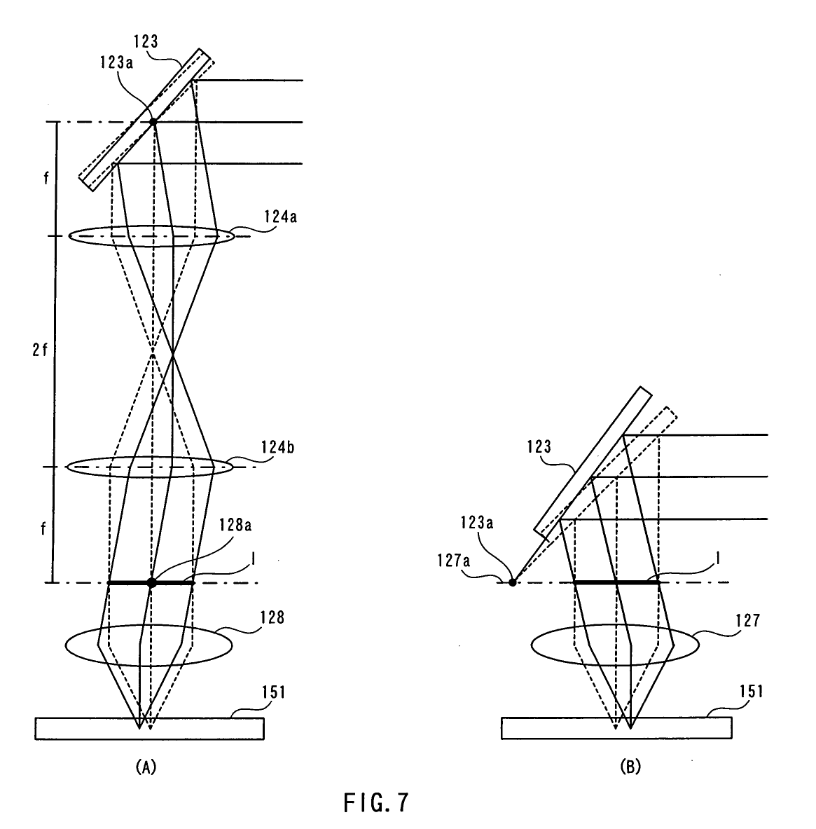

However, in many cases, the image-side focal position of the objective lens 127 is within the objective lens 127 and, in this case, the rotational center 123a of the reflective optical element 123 cannot be placed in the image-side focal position. Therefore, as shown in FIG. 7(A), a pair of relay lenses 124a and 124b can be provided between the reflective optical element 123 and the objective lens 128, and the rotational center 123a of the reflective optical element 123 can be placed in a position conjugative with the image-side focal position 128a of the objective lens 128. In other words, it is placed such that, if the focal distance of the pair of relay lenses 124a and 124b is f, the distance from the rotational center 123a of the reflective optical element 123 to one relay lens 124a is f, the distance between the pair of relay lenses 124a and 124b is 2f, and the distance from the other relay lens 124a to the image-side focal position 128a of the objective lens 128 is f. If the optical system is configured as such, image formation of the same image I (indicated by thick lines in FIG. 7(A)) to the entrance pupil plane of the objective lens 128 is performed on both the solid line optical path and the dotted line optical path, and therefore, image formation of a normal image can be performed even when the reflective optical element 123 is rotated.

In addition, as shown in FIG. 7(B), the rotational center 123a of the reflective optical element 123 can be placed within the entrance pupil plane 127a of the objective lens 127 in order to perform image formation of an almost normal image on the entrance pupil plane 127a. Because an effect wherein the image surface and the entrance pupil plane 127a are approximately fixed can be attained by placing as such, image formation of image I (indicated by thick lines in FIG. 7(B)) propagated by the pair of relay lenses 119 and 117 to the entrance pupil plane 127a can be performed almost normally. Therefore, this is preferable because, although this is an approximate, if the rotational center 123a is placed within the entrance pupil plane 127a of the objective lens 127, positioning can be performed using the reflective optical element without barely changing the size of pick-up device 102.

In FIG. 1, because the deflection element 109 performs following servo, the reflective optical element 123 is placed to enable rotation in the direction (arrow 123b) corresponding to the radial direction of the recording medium 151, orthogonal to the movement direction 151a of the recording medium 151, and is used as a positioning mechanism which performs tracking servo. However, if the reflective optical element 123 is placed to enable rotation in the direction corresponding to the movement direction 151a of the recording medium 151, it can also be used as a following servo mechanism in place of the deflection element 109.

¼ wavelength plate 125 is a phase plate which changes the optical path difference of polarized light which vibrates in a mutually vertical direction by 1/4 wavelength. The light of polarized light P is changed to circular polarized light by the ¼ wavelength plate, and furthermore, the light of this circular polarized light is changed to polarized light S after passing the ¼ wavelength plate. Through this ¼ wavelength plate, the reproduction reference light and reproduction light, when reproducing, can be separated by the second polarized beam splitter 115.

Objective lens 127 irradiates information light and reference light, of which image formation to the entrance pupil plane has been performed, to the recording medium 151 and enables interference and recording in the information recording layer, when recording. In addition, it irradiates reference light, of which image formation to the entrance pupil plane has been performed, to the recording medium 151, and incidents reproduction light generate by the recording medium 151 and performed image formation to the exit pupil surface. Furthermore, in FIG. 1, a uniaxial driving mechanism is connected to the objective lens 127 and configured such as to enable positioning of the focal point of the objective lens 127 by moving the objective lens 127 in the optical axis direction.

The servo-reading element 129 is configuration required when positioning information is recorded to the foregoing recording medium 151 beforehand and a feedback mechanism is implemented to position the irradiation position, comprising a light source for generating servo light for reading positioning information recorded to the recording medium 151 (unillustrated), for example, a semiconductor laser, and a optical detector for receiving light returned from the recording medium 151. The light source of the servo-reading element 129 preferably does not affect the information recording layer, and therefore, it preferably has a wavelength differing from that of the recording/reproduction light source 103. An infrared laser, for example, can be used as the light source of servo-reading element 129.

If providing a servo-reading element 129, it is preferable that the irradiation position of the light from the servo-reading element 129 does not move due to the following servo mechanism, even if the irradiation position of the light from the recording/reproduction light source 103 moves due to the following servo mechanism. This is because, if the light from the servo-reading element 129 follows the movement of the recording medium by the following servo mechanism when recording or reproducing, the irradiation position of the light is fixed to the predetermined position of the recording medium, and therefore, changes in positions due to movement of the recording medium cannot be read. Because positioning information can be read while recording or reproducing when the irradiation position of the light from the servo-element 129 moves due to the following servo mechanism, the irradiation position can be aligned more accurately to the recording or reproduction position and the quality of recording/reproduction is enhanced.

Furthermore, it is preferable that irradiation position of the light from the servo-reading element 129 is changed by the tracking servo, in order to obtain the positioning information of the same track as the light from the recording/reproduction light source 103. In the pick-up device 102, shown in FIG. 1, because the reflective optical element 123 performs tracking servo as the positioning mechanism, the irradiation position of the light from the servo-reading element 129 is changed by the tracking servo.

The second collimator lens 131 enables laser light returned from the recording medium 151 to be converged by the optical detector of the servo-reading element 129, with servo light from the servo-reading element 129 as almost a parallel light beam.

Optical detector 133 has numerous pixels aligned in a lattice and can detect the intensity of light received by each pixel. A CCD-type solid-state image sensing device and MOS-type solid-state image sensing device can be used as optical detector 133. In addition, smart optical sensor, wherein MOS-type solid-state image sensing device and signal processing circuit are integrated on one chip, (for example, refer to reference “O plus E, September 1996, No. 202, Pages 93 to 99”) can be used as the optical detector 133. This smart optical sensor has a large transfer rate and enables high-speed reproduction, for example, enabling reproduction at a transfer rate of G(giga)bit/second order.

The operations of the optical information recording and reproduction device 101, shown in FIG. 1, are described below. First, the operations when reading servo, shared by the recording and reproduction device, is described.

Light emitted from the servo-reading element 129 is turned into parallel light by the second collimator lens 131, and this parallel light passes through dichroic mirror 121, is reflected towards the objective lens 127 by the reflective optical element 123, and passes through the ¼ wavelength plate 125. Then, it is irradiated by the objective lens 127 onto the layer of the recording medium to which positioning information has been recorded, reflected by the reflective layer of the recording medium 151, is once again incident on the servo-reading element 129, via the reverse route, and the positioning information is read. The read positioning information is transmitted to control means 163 (refer to FIG. 5), whether or not the irradiation position is the predetermined irradiation position is determined by the control means 163, and if it is misaligned from the predetermined irradiation position, this is fed back to the positioning mechanism of the pick-up driving means 162 and pick-up device 102.

Next, the operations as an optical information recording device are described. Light emitted from the light source 103 is turned into a parallel light by the collimator lens 105, and the beam intensity distribution this parallel light is equalized by the optical element 107. The traveling direction of the parallel light, of which the beam intensity distribution has been equalized, is changed to face the first polarized beam splitter 111 by the deflection element 109, and is reflected towards the spatial light modulator 113 by the first polarized beam splitter 111. Then, information light and recording reference light is generated by the two-dimensional digital pattern information expressed in spatial light modulator 113. Information light and recording reference light pass though the first and second polarized beam splitters 111 and 115 and are propagated by the pair of relay lenses 117 and 119, such that image formation of the two-dimensional digital pattern information expressed in the spatial light modulator 113 to the entrance pupil plane of the objective lens 172 is performed. During this, the lights are reflected towards the reflective optical lens 127 by the reflective optical element 123 and passes through the ¼ wavelength plate 125. Then, they are irradiated onto the recording medium 151 by the objective lens 127 and the interference patterns of the information light and the recording reference light are recorded to the information recording layer of the recording medium 151.

Furthermore, operations as an optical information reproduction device are described. Light emitted from the light source 103 is turned into a parallel light by the collimator lens 105, and the beam intensity distribution of this parallel light is equalized by the optical element 107. The traveling direction of the parallel light, of which the beam intensity distribution has been equalized, is changed to face the first polarized beam splitter 111 by the deflection element 109 and reflected towards the spatial light modulator 113 by the first polarized beam splitter 111. Then, reproduction reference light is generated by the two-dimensional digital pattern information expressed in the spatial light modulator. The two-dimensional digital pattern information of the reproduction reference light is the two-dimensional digital pattern information of the recording reference light irradiated when information recorded to the recording medium was recorded. Reproduction reference light passes through the first and second polarized beam splitters 111 and 115 and is propagated by the pair of relay lenses 117 and 119, such that image formation of the two-dimensional digital pattern information expressed in the spatial light modulator 113 to the entrance pupil plane of the objective lens 172 is performed. During this, the light is reflected towards the reflective optical element 123 by the dichroic mirror 121, reflected towards the objective lens 127 by the reflective optical element 123, and passes through the ¼ wavelength plate 125. Then, it is irradiated onto the recording medium 151 by the objective lens 127, diffracted by the interference pattern recorded to the information recording layer of the recording medium 151, and reproduction light having the same information as the information light when recording is generated.

Reproduction light is emitted towards the objective lens 127 from the recording medium 151 by the reflective layer of the recording medium 151, image formation of the two-dimensional digital pattern information is performed by the objective lens 127 on the exit pupil surface thereof, and propagated by the pair of relay lenses 119 and 117 such that image formation is, once again, performed on this image to the optical detector 133. During this, the light passes through the ¼ wavelength plate 125, is reflected towards the dichroic mirror 121 by the reflective optical element 123, and reflected towards the second polarized beam splitter 115 by the dichroic mirror 121. In the second polarized beam splitter 115, reproduction light is reflected towards the optical detector 133 because, compared to the reproduction reference light during irradiation, it passes through the ¼ wavelength plate twice and the polarized light direction is misaligned by 90°. Finally, two-dimensional digital pattern information of the reproduction light is detected by the optical detector 133, the detected information is sent to the control means 163, decoded by the control means 163, and the information is reproduced.

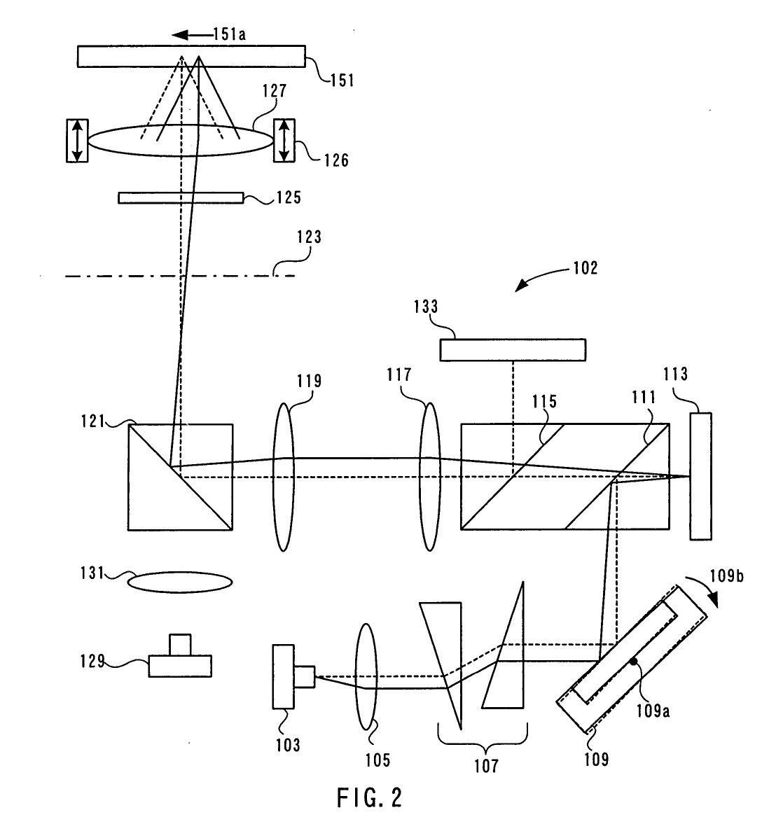

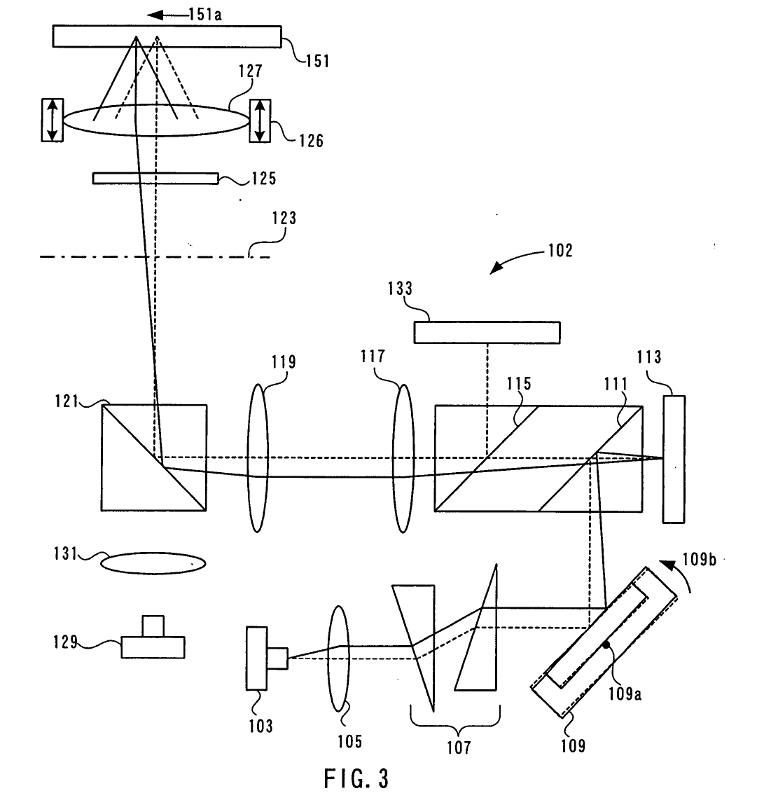

The operations for performing following servo by the deflection element 109 in this recording/reproduction device 101 are described using FIG. 1 to FIG. 3. In the pick-up device 102 in FIG. 1(A), because the recording medium 151 is moving the direction of arrow 151a, irradiation position is moved from the right-side to the left-side, in order to enable the irradiation position when recording or reproducing to follow the movement of the recording medium 151. FIG. 1 shows a pick-up device 102 of when the irradiation position is to the right-side. In order to make the movement of the irradiation position easier to understand, the optical path before and after the reflection due to the reflective optical element 123 (indicated by dashed lines) is illustrated such as to be on the same plane in FIG. 2 and FIG. 3, and furthermore, optical axes and deflection elements in FIG. 1 are shown by dotted lines.

In FIG. 2, the deflection element 109 is rotated clockwise (arrow 109b) from the position of FIG. 1, with the axis 109a perpendicular to the paper surface as the center. Therefore, light emitted from the light source 103, turned into parallel light by the collimator 105, and of which the beam intensity distribution has been equalized by the optical element 107, proceeds at a right diagonal to the optical path in FIG. 1 by the deflection element 109, as shown by the solid lines. Subsequently, as a result of going by way of each optical element, the irradiation position irradiated to the recording medium by the objective lens 127 is to the right-side (upstream of the movement direction of the recording medium 151), compared to the irradiation position in FIG. 1.

Furthermore, as shown in FIG. 3, if the deflection element 109 is rotated counterclockwise (arrow 109b) from the position in FIG. 1, with the axis 109a perpendicular to the paper surface as the center, the emission light from the deflection element 109 proceeds at a left diagonal to the optical path in FIG. 1. Subsequently, as a result of going by way of each optical element, the irradiation position irradiated to the recording medium 151 by the objective lens 127 is to the left-side (downstream of the movement direction of the recording medium 151), compared to the irradiation position in FIG. 1.

By rotating the deflection element 109 in this way, the irradiation position in the recording medium 151 can be moved, and therefore, following servo can be performed by enabling the rotation of the deflection element 109 to correspond to the movement of the recording medium 151 by the control means. Because all which is required is slight change to the deflection direction of light, with the following servo by the deflection element 109, positioning can be performed more quickly and easily than following the movement of the recording medium with the pick-up device per se. In addition, if driving means for rotating the optical element is used, the precision of positioning can be enhanced and a more accurate recording and reproduction of information can be made because the driving means rotating the optical element can respond to slight changes with precision.

In addition, in the configuration of the pick-up device 102 in FIG. 1 to FIG. 3, because light from the servo-reading element 129 is irradiated to the recording medium 151 without going through deflection element 109, light from the servo-reading element 129 does not move, even if the irradiation positions of information light and reference light move buy performing following servo by deflection element 109. Therefore, because positioning can be performed while recording or reproducing, irradiation position can be aligned with more precision to the recording or reproduction position, and the quality of recording/reproduction is enhanced.

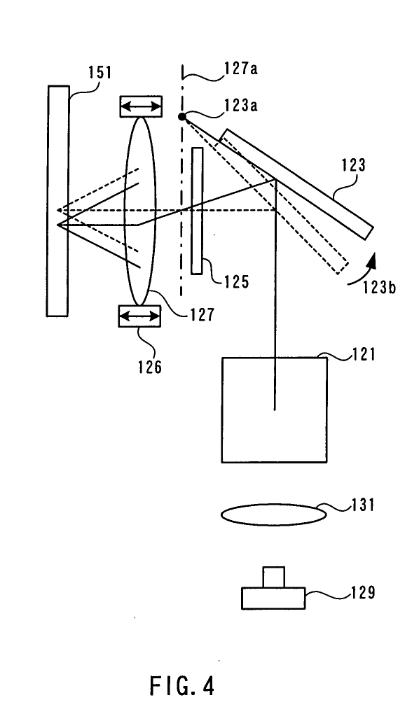

Next, the operations of the tracking servo by the reflective optical element 123 in this recording/reproduction device 101 are described using FIG. 1 and FIG. 4. FIG. 4 is a diagram corresponding to FIG. 1(B) when the reflective optical element 123 is rotated. In order to clarify the movement of the irradiation position, the optical axis and reflective optical element 123 in FIG. 1 are indicated by dotted lines in FIG. 4.

As shown in FIG. 1 and FIG. 4, the reflective optical element 123 of the present invention can rotate in the direction (arrow 123b) corresponding to the radial direction of the recording medium 151, with the rotational center 123a positioned in the entrance pupil plane 127a of the objective lens 127 as the axis. In addition, as shown in FIG. 1, if the reflective optical element 123 is rotated counterclockwise (arrow 123b), light from the dichroic mirror 121 is reflected obliquely towards the objective lens 127. As described earlier, because the rotational center 123a of the reflective optical element 123 is placed within the entrance pupil plane 127a of the objective lens 127, an image formation of an almost normal image can be formed in the entrance pupil plane 127a, even when the reflective optical element 123 is rotated.

Because the irradiation position in the recording medium can be moved by rotating the reflective optical element 123 as such, tracking servo can be performed by rotating the reflective optical element 123 such as to be in the predetermined irradiation position by the control means 163. In addition, in the recording/reproduction device 101 of the present embodiment, although tracking servo is performed by the reflective optical element 123 by enabling rotation in the direction (arrow 123b) corresponding to the radial direction of the recording medium 151, following servo can also be performed by changing the rotational direction, enabling rotation in the direction corresponding the movement direction of the recording medium 151, and corresponding the rotation of the reflective optical element 123 with the movement of recording medium 151 by the control means 163.

Positioning mechanism by the reflective optical element 123 enables positioning to be performed more quickly and easily than by moving the pick-up device per se, because all which is required is change in the reflective direction of light. In addition, if the driving means for rotating the optical element is used, the precision of positioning can be enhanced and a more accurate recording and reproduction of information can be performed because the driving means for driving the optical element responds to slight changes with precision.

In addition, in the recording/reproduction device 101 of the present embodiment, because the rotational center 123a of the reflective optical element 123 is placed within the entrance pupil plane 127a of the objective lens 127, an image formation of an almost normal image can be formed in the entrance pupil plane 127a, and thus, an accurate information recording and reproduction can be performed.

In addition, control means 126 controls the uniaxial driving mechanism connected to the objective lens 127, the objective lens 127 is moved in the optical axis direction, and positioning is performed to the focal point of the objective lens 127.

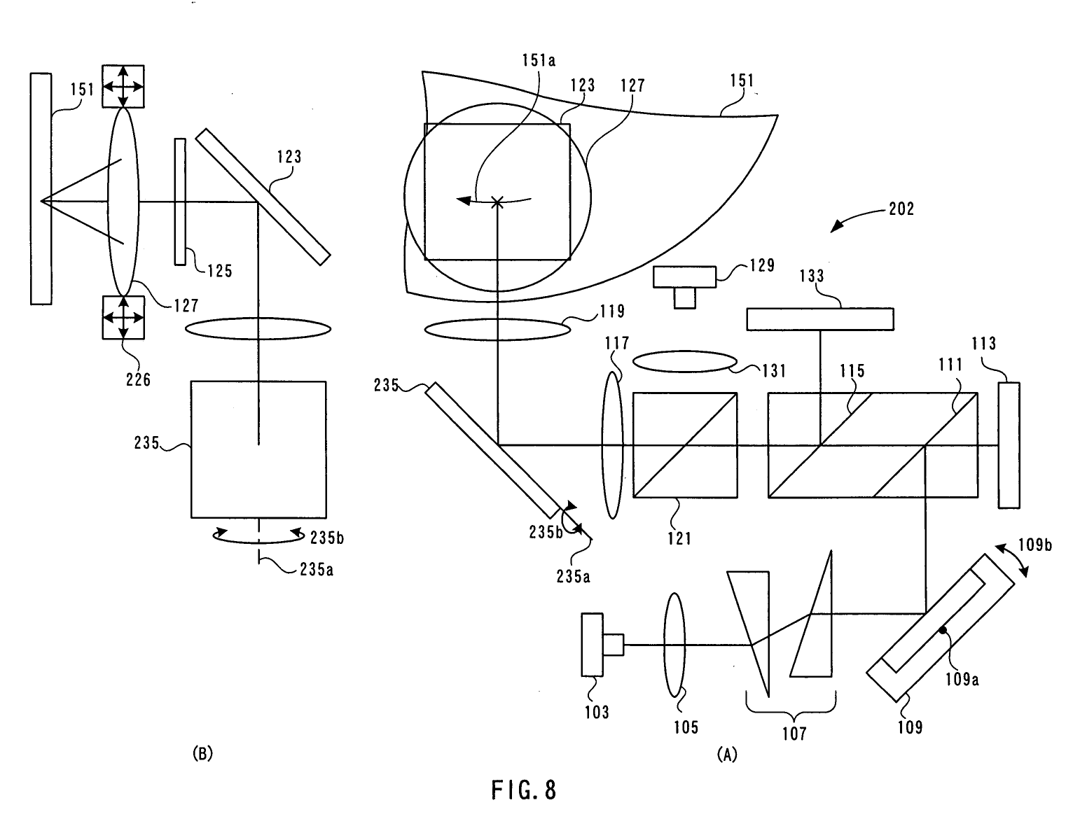

FIG. 8 is a diagram showing another embodiment of the pick-up device 202. (A) is a top view (view seen from the direction facing the recording medium 151) and (B) is a side view of the pick-up device 202 (view of the cross-section in the radial direction in the irradiation position of the recording medium 151). In FIG. 8, the same constituents as those in FIG. 1 are indicated by the same reference number and explanations are omitted.

The pick-up device 202 in FIG. 8 comprises a light source 103 for recording/reproduction for irradiating recording/reproduction light, a first collimator lens 105, an optical element 107 for equalizing beam intensity, deflection element 109, a first polarized beam splitter 111, a spatial light modulator (information expression means) 113, a second polarized beam splitter 115, a dichroic mirror 121, one relay lens 117, the first reflective optical element 235, the other relay lens 119, the second reflective optical element 123, a ¼ wavelength plate 125, an objective lens 127, a servo-reading element 129, a second collimator lens 131, and an optical detector 133.

The first reflective optical element 235 has a reflective surface in the focal position between the pair of relay lenses 117 and 119 and is provided to enable rotation. Although a mirror is generally used as the first reflective optical element 235, a reflective prism and the like can be used, as well. The first reflective optical element 235 functions as a positioning mechanism for irradiation position, in conjunction with the driving mechanism 226 for moving the objective lens 127 parallel to the front surface of the recording medium 151.

Because the deflection element 109 performs the following servo in the pick-up device 202 in FIG. 8, as well, the first reflective optical element 235 is provided to enable rotation in the direction (arrow 235b) corresponding to the radial direction of the recording medium 151 and is used as a positioning mechanism which performs tracking servo. However, if the first reflective optical element 235 is provided to enable rotation in the direction corresponding to the movement direction 151a of the recording medium 151, it can be used as a following servo mechanism in place of the deflection element 109. In this case, the second reflective optical element 123 can be provided to enable rotation and perform tracking servo as the positioning mechanism which performs tracking servo.

Furthermore, if the first reflective optical element 235 is a biaxial positioning mechanism enabling rotation in the direction corresponding to the radial direction and the movement direction 151a of the recording medium 151, respectively, the following servo and tracking servo can be performed simultaneously. In this case, the driving mechanism 226 of the objective lens 127 must also be able to rotate in the biaxial direction parallel to the front surface of the recording medium 151.

In addition, when using the first reflective optical element 235 as a positioning mechanism for performing tracking servo, it is preferable to place the dichroic mirror 121, the servo-reading element 129 and the second collimator lens 131 on the light source-side, rather than the first reflective optical element 235. If servo-reading element 129 and the like are placed as such, the irradiation position of the servo-reading light is also changed by the first reflective optical element 235, and thus, positioning information of the same track as the light from the recording/reproduction light source 103 can be obtained. Furthermore, if the servo-reading element 129 and the like are placed between the first reflective object element 235 and the deflection element 109, this is preferable because positioning information can be read while recording or reproducing since the irradiation position of the servo-reading light does not move due to the following servo mechanism, and therefore, irradiation position can be aligned in the recording or reproduction position with more accuracy and the quality of recording/reproduction is enhanced. In FIG. 8, the dichroic mirror 121, servo-reading element 129, and the second collimator lens 131 are placed between one relay lens 117 and the second polarized beam splitter 115.

Driving mechanism 226 connected to the objective lens 127 can be moved parallel to the front surface of the recording medium 151. Furthermore, the driving mechanism 226 can be configured such as to enable moving of the objective lens 127 in the optical axis direction and positioning of the focal point of the objective lens 127. In FIG. 8, the driving mechanism 226 is biaxial, and configured to enable movement in the radial direction and the optical axis direction of the recording medium 151. Because the driving mechanism for objective lens used in CD drives and DVD drives can be used as the driving mechanism 226, it can be obtained at low cost. Furthermore, this is preferable because, by implementing a driving mechanism which is shared by CD drives and DVD drives, compatibility with CD drives and DVD drives can be facilitated.

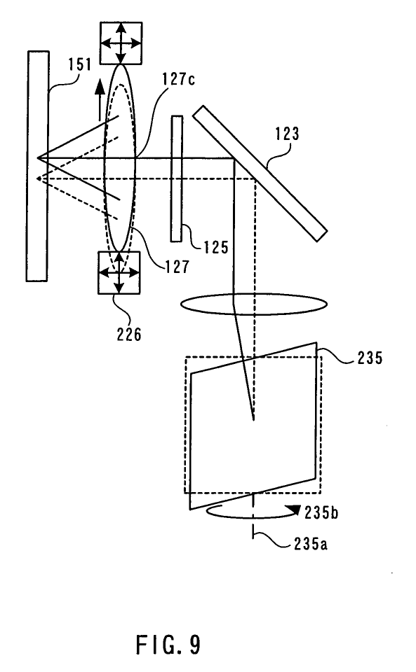

Next, the operations of the tracking servo by the second reflective optical element 235 in this recording/reproduction device 201 are described using FIG. 8 and FIG. 9. FIG. 9 is a diagram corresponding to FIG. 8(B), in a state wherein the irradiation position is moved. In order to clarify the movement of the irradiation position, the optical axis, the second reflective optical element and the objective lens in FIG. 8 are indicated by dotted lines, in FIG. 9.

As shown in FIG. 8 and FIG. 9, the second reflective optical element 235 of the present embodiment is used as a positioning mechanism for tracking servo, and therefore, can rotate in the direction (arrow 235b) corresponding to the radial direction of the recording medium 151, with the axis 235a parallel to the reflective surface and the front surface of the recording medium 151 as the center. Furthermore, because the driving mechanism 226 is used as a positioning mechanism for tracking servo, it is configured to enable the objective lens 127 to move in the radial direction of the recording medium 151.

In addition, as shown in FIG. 9, the second reflective optical element 235 is rotated by the driving mechanism 226, such as to move the objective lens 127 to the predetermined irradiation position and position the optical path of the incident light to the center 127c of the objective lens 127, as well. In FIG. 9, the reflective surface of the second reflective optical element 235 is rotated in the direction of arrow 235b, such as to face the recording medium-side. Then, convergence light from one relay lens 117 is reflected obliquely towards the other relay lens 119 by the second reflective optical element 235 and turned into parallel light by the other relay lens 119. In this way, the optical path towards the objective lens 127 (indicated by solid line) can be moved in parallel to the optical path in FIG. 8 (dotted line), and the optical path of incident light can be aligned with the center 127c of the objective lens 127.

Therefore, because incident light incident to the objective lens 127 also moves, even if the objective lens 127 moves, information light, recording reference light, or reproduction reference light can be irradiated at the same angle to the recording medium, and thus, a more accurate recording/reproduction of information can be performed.

In FIG. 8, although the deflection element 109 is used as the following servo mechanism, the second reflective optical element 123 can be provided to enable rotation and used as the following servo mechanism.

The present invention is not limited to the foregoing embodiments, and various modifications can be made as required. For example, if only the section of the optical information recording/reproduction device in embodiments above used when recording is implemented, it can become an optical information recording device, and, if only the section used when reproducing is implemented, it can become an optical information reproduction device.

What is claimed is:

1. An optical information recording device utilizing holography, comprising:
a light source;
a deflection element for changing the traveling direction of light emitted from the light source;
a means for generating information light holding information using light of which the traveling direction has been changed by the deflection element;
a means for generating recording reference light using light of which the traveling direction has been changed by the deflection element;
an objective lens for irradiating information light and recording reference light to the moving recording medium; and
a control means for controlling the deflection element and enabling the irradiation position of the objective lens to the recording medium to follow the movement of the recording medium.

2. An optical information recording device utilizing holography, comprising:
a light source;
a deflection element for changing the traveling direction of light emitted from the light source, said deflection element comprising a reflective optical element and a driving means for rotating the reflective optical element;
a means for generating information light holding information using light of which the traveling direction has been changed by the deflection element;
a means for generating recording reference light using light of which the traveling direction has been changed by the deflection element;
an objective lens for irradiating information light and recording reference light to the moving recording medium; and
a control means for controlling the deflection element and enabling the irradiation position of the objective lens to the recording medium to follow the movement of the recording medium.

3. The optical information recording device according to claim 1, wherein said light incident to the deflection element is parallel light of which the beam intensity distribution has been equalized.

4. The optical information recording device according to claim 2, wherein said light incident to the deflection element is parallel light of which the beam intensity distribution has been equalized.

5. The optical information recording device according to any one of claims 1 to 4, comprising a positioning mechanism for rotating reflective optical element for directing the traveling direction of said information light and said recording reference light to said objective lens and changing the irradiation position to said recording medium.

6. The optical information recording device according to claim 5, wherein the rotational center of said reflective optical element of the positioning mechanism is positioned in an entrance pupil plane of said objective lens.

7. The optical information recording device according to any one of claims 1 to 4, comprising:
a pair of relay lenses for performing image formation of said information light and said recording reference light on an entrance pupil plane of said objective lens;
a reflective optical element placed in the focal position between the pair of relay lenses; and
a driving means for rotating this reflective optical element; wherein
the objective lens can be moved in a direction parallel to the front surface of the recording medium; and
the reflective optical element between the pair of relay lenses is rotated in correspondence to the movement of the objective lens.

8. An optical information recording device utilizing holography, comprising:
a light source;
a means for generating information light holding information using light emitted from the light source;
a means for generating recording reference light using light emitted from the light source;
a reflective optical element for directing the traveling direction of the information light and the recording reference light to the objective lens;
a driving means for rotating the reflective optical element; and
an objective lens for irradiating the information light and the recording reference light to the recording medium; wherein
the rotational center of the reflective optical element of the positioning mechanism is positioned in the entrance pupil plane of the objective lens.

9. An optical information recording device utilizing holography, comprising:
a light source;
a means for generating information light holding information using light emitted from the light source;
a means for generating recording reference light using light emitted from the light source;
a pair of relay lenses for performing image formation of the information light and recording reference light on the entrance pupil plane of the objective lens;
a reflective optical element placed in the focal position between the pair of relay lenses;
a driving means for rotating this reflective optical element; and
an objective lens for irradiating the information light and the recording reference light to the recording medium; wherein
the objective lens can be moved in a direction parallel to the front surface of the recording medium; and
the reflective optical element can be rotated in correspondence to the movement of the objective lens.

10. An optical information reproduction device utilizing holography, comprising:
a light source;
a deflection element for changing the traveling direction of light emitted from the light source;
a means for generating reproduction reference light using light of which the traveling direction has been changed by the deflection element;
an objective lens for irradiating the reproduction reference light to a moving recording medium and receiving reproduction light generated from the recording medium; and
a control means for controlling the deflection element and enabling the irradiation position of the objective lens to the recording medium to follow the movement of the recording medium.

11. An optical information reproduction device utilizing holography, comprising:
a light source;
a deflection element for changing the traveling direction of light emitted from the light source, said deflection element comprising a reflective optical element and a driving means for rotating the reflective optical element;
a means for generating reproduction reference light using light of which the traveling direction has been changed by the deflection element;
an objective lens for irradiating the reproduction reference light to a moving recording medium and receiving reproduction light generated from the recording medium; and
a control means for controlling the deflection element and enabling the irradiation position of the objective lens to the recording medium to follow the movement of the recording medium.

12. The optical information reproduction device according to claim 10, wherein said light incident to the deflection element is parallel light of which the beam intensity distribution has been equalized.

13. The optical information reproduction device according to claim 1, wherein said light incident to the deflection element is parallel light of which the beam intensity distribution has been equalized.

14. The optical information reproduction device according to any one of claims 10 to 13, comprising a positioning mechanism for rotating reflective optical element for directing the traveling direction of said reproduction reference light to said objective lens and changing the irradiation position to said recording medium.

15. The optical information recording device according to claim 14, wherein the rotational center of said reflective optical element of the positioning mechanism is positioned in an entrance pupil plane of said objective lens.

16. The optical information reproduction device according to any one of claims 10 to 13, comprising:
a pair of relay lenses for performing image formation of said reproduction reference light on an entrance pupil plane of said objective lens;
a reflective optical element placed in the focal position between the pair of relay lenses; and
a driving means for rotating this reflective optical element; wherein
the objective lens can be moved in a direction parallel to the front surface of the recording medium; and
the reflective optical element between the pair of relay lenses is rotated in correspondence to the movement of the objective lens.

17. An optical information reproduction device utilizing holography, comprising:
a light source;
a means for generating reproduction reference light using light emitted from the light source;
a reflective optical element for directing the traveling direction of the reproduction reference light to the objective lens;
a driving means for rotating the reflective optical element; and
an objective lens for irradiating the reproduction reference light to the recording medium; wherein
the rotational center of the reflective optical element of the positioning mechanism is positioned in the entrance pupil plane of the objective lens.

18. An optical information reproduction device utilizing holography, comprising:
a light source;
a means for generating reproduction reference light using light emitted from the light source;
a pair of relay lenses for performing image formation of the reproduction reference light on the entrance pupil plane of the objective lens;
a reflective optical element placed in the focal position between the pair of relay lenses;
a driving means for rotating this reflective optical element; and
an objective lens for irradiating the reproduction reference light to the recording medium; wherein
the objective lens can be moved in a direction parallel to the front surface of the recording medium; and
the reflective optical element can be rotated in correspondence to the movement of the objective lens.
